(19) United States
(12) Patent Application Publication
(10) Pub. No.: US 2015/0315974 A1
(43) Pub. Date: Nov. 5, 2015

(54) TWO SPOOL GAS GENERATOR WITH IMPROVED PRESSURE SPLIT

(71) Applicant: United Technologies Corporation, Hartford, CT (US)

(72) Inventors: Gabriel L. Suciu, Glastonbury, CT (US); Brian D. Merry, Andover, CT (US); Karl L. Hasel, Manchester, CT (US); Jessica Tsay, West Hartford, CT (US)

(21) Appl. No.: 14/649,265

(22) PCT Filed: May 29, 2013
(86) PCT No.: PCT/US2013/043029

§ 371 Date: Jun. 3, 2015

Related U.S. Application Data
(60) Provisional application No. 61/737,996, filed on Dec. 17, 2012.
(60) Provisional application No. 61/739,243, filed on Dec. 19, 2012.

(51) Int. Cl. F02C 9/00

(52) U.S. Cl. CPC F02C 9/00

(57) ABSTRACT

A gas turbine engine has a first shaft including a first compressor rotor. A second shaft includes a second compressor rotor disposed upstream of the first compressor rotor. The second compressor rotor has a first overall pressure ratio. The first compressor rotor has a second overall pressure ratio, with a ratio of the first overall pressure ratio to the second overall pressure ratio being greater than or equal to about 3.0.

### BACKGROUND

This application relates to a two spool gas generator for a gas turbine engine and a propulsor drive.

Conventional gas turbine engines typically include a fan section, a compressor section and a turbine section. There are two general known architectures. In one architecture, a low speed spool includes a low pressure turbine driving a low pressure compressor and also driving a fan. A gear reduction may be placed between the spool and the fan in some applications. There are also direct drive engines.

Another known architecture includes a third spool with a third turbine being positioned downstream of the low pressure turbine and driving the fan. The three spools have shafts connecting a turbine to the driven element, and the three shafts are mounted about each other.

All of these architectures raise challenges.

### SUMMARY

In a featured embodiment, a gas turbine engine has a first shaft including a first compressor rotor. A second shaft includes a second compressor rotor disposed upstream of the first compressor rotor. The second compressor rotor has a first overall pressure ratio. The first compressor rotor has a second overall pressure ratio, with a ratio of the first overall pressure ratio to the second overall pressure ratio being greater than or equal to about 3.0.

In another embodiment according to the previous embodiment, the ratio of the first overall pressure ratio to the second overall pressure ratio is greater than or equal to about 3.5.

In another embodiment according to any of the previous embodiments, the ratio of the first overall pressure ratio to the second overall pressure ratio is less than or equal to about 8.0.

In another embodiment according to any of the previous embodiments, a first turbine rotor drives the first shaft to drive the first compressor rotor, and a second turbine rotor drives the second shaft to drive the second compressor rotor.

In another embodiment according to any of the previous embodiments, the first turbine rotor includes a single turbine stage.

In another embodiment according to any of the previous embodiments, the second turbine rotor includes two stages.

In another embodiment according to any of the previous embodiments, the second compressor rotor includes eight stages.

In another embodiment according to any of the previous embodiments, the first compressor rotor includes six stages.

In another embodiment according to any of the previous embodiments, a propulsor turbine is positioned downstream of the second turbine rotor.

In another embodiment according to any of the previous embodiments, the propulsor turbine drives a propeller.

In another embodiment according to any of the previous embodiments, the propulsor turbine drives a fan at an upstream end of the engine.

In another embodiment according to any of the previous embodiments, an axially outer position is defined by the fan, and the propulsor turbine is positioned between the fan and the first and second turbine rotors. The first and second compressor rotors are positioned further into the engine relative to the first and second turbine rotors.

In another embodiment according to any of the previous embodiments, the first turbine rotor includes a single turbine stage.

In another embodiment according to any of the previous embodiments, the second turbine rotor includes two stages.

In another embodiment according to any of the previous embodiments, the second compressor rotor includes eight stages.

In another embodiment according to any of the previous embodiments, the first compressor rotor includes six stages.

In another embodiment according to any of the previous embodiments, the second compressor rotor includes eight stages.

In another embodiment according to any of the previous embodiments, the first compressor rotor includes six stages.

In another embodiment according to any of the previous embodiments, the ratio of the first overall pressure ratio to the second overall pressure ratio is less than or equal to about 8.0.

In another featured embodiment, a gas turbine engine has a first shaft connecting a first compressor rotor to be driven by a first turbine rotor, and a second shaft connecting a second compressor rotor to be driven by a second turbine rotor. The second compressor rotor is upstream of the first compressor rotor, and the first turbine rotor is upstream of the second turbine rotor. The second compressor rotor has a first overall pressure ratio, and the first compressor rotor has a second overall pressure ratio. A ratio of the first overall pressure ratio to the second overall pressure ratio is greater than or equal to about 2.0. A propulsor turbine operatively connects to drive one of a fan or a propeller through a third shaft. The first shaft surrounds the second shaft, but the first and second shaft do not surround the third shaft.

In another embodiment according to the previous embodiment, the ratio of the first overall pressure ratio to the second overall pressure ratio is greater than about 3.0.

In another embodiment according to any of the previous embodiments, the ratio of the first overall pressure ratio to the second overall pressure ratio is less than or equal to about 8.0.

In another embodiment according to any of the previous embodiments, the first turbine rotor includes a single turbine stage.

In another embodiment according to any of the previous embodiments, the second turbine rotor includes two stages.

In another embodiment according to any of the previous embodiments, the second compressor rotor includes eight stages.

In another embodiment according to any of the previous embodiments, the first compressor rotor includes six stages.

In another embodiment according to any of the previous embodiments, the ratio of the first overall pressure ratio to the second overall pressure ratio is greater than or equal to about 3.5.

In another embodiment according to any of the previous embodiments, the propulsor turbine drives a propeller.

In another embodiment according to any of the previous embodiments, the propulsor turbine drives a fan at an upstream end of the engine.

In another embodiment according to any of the previous embodiments, the propulsor turbine is connected to the fan by a gear reduction.

In another embodiment according to any of the previous embodiments, an axially outer position is defined by the fan. The propulsor turbine is positioned between the fan and the first and second turbine rotors. The first and second compressor rotors are positioned further into the engine relative to the first and second turbine rotors.

In another embodiment according to any of the previous embodiments, the first turbine rotor includes a single turbine stage.

In another embodiment according to any of the previous embodiments, the second turbine rotor includes two stages.

In another embodiment according to any of the previous embodiments, the second compressor rotor includes eight stages.

In another embodiment according to any of the previous embodiments, the first compressor rotor includes six stages.

In another embodiment according to any of the previous embodiments, the second compressor rotor includes eight stages.

In another embodiment according to any of the previous embodiments, the first compressor rotor includes six stages.

In another embodiment according to any of the previous embodiments, the first compressor rotor includes six stages.

In another embodiment according to any of the previous embodiments, the ratio of the first overall pressure ratio to the second overall pressure ratio is less than or equal to about 8.0.

These and other features may be best understood from the following drawings and specification.

### BRIEF DESCRIPTION OF THE DRAWINGS

FIG. 1 schematically shows a three spool gas turbine engine.

FIG. 2 shows a second embodiment.

### DETAILED DESCRIPTION

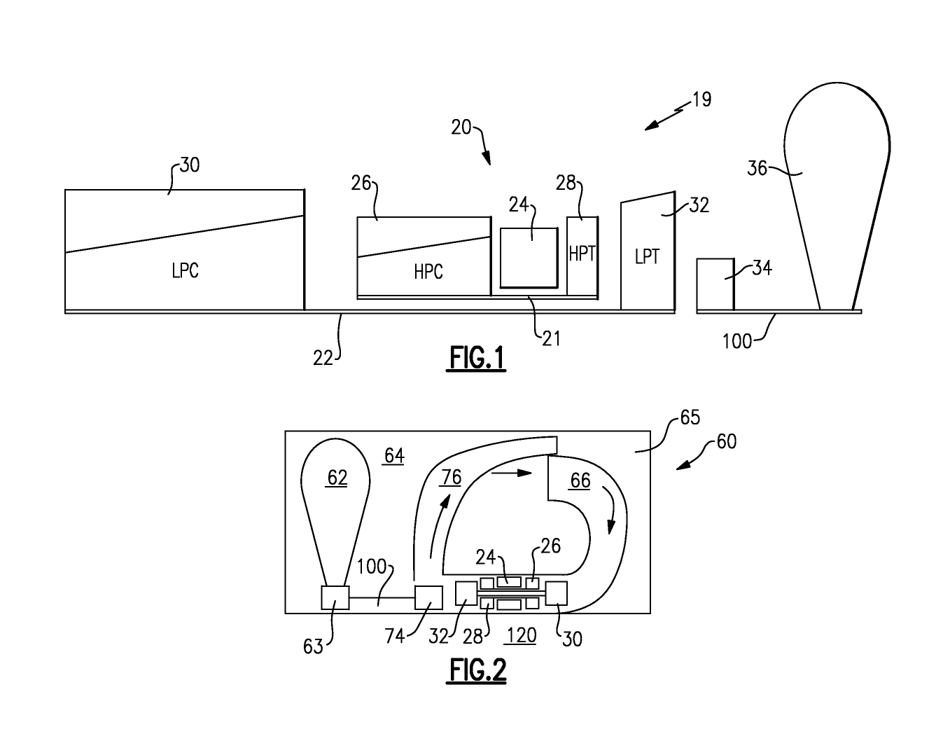

A gas turbine engine 19 is schematically illustrated in FIG. 1. A core engine, or gas generator 20, includes high speed shaft 21 is part of a high speed spool along with a high pressure turbine rotor 28 and a high pressure compressor rotor 26. A combustion section 24 is positioned intermediate the high pressure compressor rotor 26 and the high pressure turbine rotor 28. A shaft 22 of a low pressure spool connects a low pressure compressor rotor 30 to a low pressure turbine rotor 32.

Engine 19 also includes a free turbine 34 is shown positioned downstream of the low pressure turbine rotor 32 and serves to drive a propeller 36.

Various embodiment are within the scope of the disclosed engine. These include embodiments in which:

a good deal more work is done by the low pressure compressor rotor 30 than by the high pressure compressor rotor 26;

the combination of the low pressure compressor rotor 30 and high pressure compressor rotor 26 provides an overall pressure ratio equal to or above about 30;

the low pressure compressor rotor 30 includes eight stages and has a pressure ratio at cruise conditions of 14.5;

the high pressure compressor rotor 26 had six stages and an overall pressure ratio of 3.6 at cruise;

a ratio of the low pressure compressor pressure ratio to the high pressure compressor ratio is greater than or equal to about 2.0, and less than or equal to about 8.0;

more narrowly, the ratio of the two pressure ratios is between or equal to about 3.0 and less than or equal to about 8; and

even more narrowly, the ratio of the two pressure ratios is greater than about 3.5.

In the above embodiments, the high pressure compressor rotor 26 will rotate at slower speeds than in the prior art. If the pressure ratio through the fan and low pressure compressor are not modified, this could result in a somewhat reduced overall pressure ratio. The mechanical requirements for the high pressure spool, in any event, are relaxed.

With the lower compressor, the high pressure turbine rotor 28 may include a single stage. In addition, the low pressure turbine rotor 32 may include two stages.

By moving more of the work to the low pressure compressor rotor 30, there is less work being done at the high pressure compressor rotor 26. In addition, the temperature at the exit of the high pressure compressor rotor 26 may be higher than is the case in the prior art, without undue challenges in maintaining the operation.

Variable vanes are less necessary for the high pressure compressor rotor 26 since it is doing less work. Moreover, the overall core size of the combined compressor rotors 30 and 26 is reduced compared to the prior art.

The engine 60 as shown in FIG. 2 includes a two spool core engine 120 including a low pressure compressor rotor 30, a low pressure turbine rotor 32, a high pressure compressor rotor 26, and a high pressure turbine rotor 28, and a combustor 24 as in the prior embodiments. This core engine 120 is a so called “reverse flow” engine meaning that the compressor 30/26 is spaced further into the engine than is the turbine 28/32. Air downstream of the fan rotor 62 passes into a bypass duct 64, and toward an exit 65. However, a core inlet duct 66 catches a portion of this air and turns it to the low pressure compressor 30. The air is compressed in the compressor rotors 30 and 26, combusted in a combustor 24, and products of this combustion pass downstream over the turbine rotors 28 and 32. The products of combustion downstream of the turbine rotor 32 pass over a fan drive turbine 74. Then, the products of combustion exit through an exit duct 76 back into the bypass duct 64 (downstream of inlet 66 such that hot gas is not re-ingested into the core inlet 65), and toward the exit 65. A gear reduction 63 may be placed between the fan drive turbine 74 and fan 62.

The core engine 120, as utilized in the engine 60, may have characteristics similar to those described above with regard to the core engine 20.

The engines 19 and 60 are similar in that they have what may be called a propulsor turbine (34 or 74) which is axially downstream of the low pressure turbine rotor 32. Further, the high pressure spool radially surrounds the low pressure spool, but neither of the spools surround the propulsor turbine, nor the shaft 100 connecting the propulsor turbine to the propellers 36 or fan 62. In this sense, the propulsor rotor is separate from the gas generator portion of the engine.

The disclosed engine architecture creates a smaller core engine and yields higher overall pressure ratios and, therefore, better fuel consumption. Further, uncoupling the low pressure turbine 32 from driving a fan 62 or prop 36 enables it to run at a lower compressor surge margin, which also increases efficiency. Moreover, shaft diameters can be decreased and, in particular, for the diameter of the low pressure shafts as it is no longer necessary to drive the fan 62 or prop 36 through that shaft.

In the prior art, the ratio of the low pressure compressor pressure ratio to the high pressure compressor ratio was generally closer to 0.1 to 0.5. Known three spool engines have a ratio of the low pressure compressor pressure ratio to the high pressure compressor ratio of between 0.9 and 3.0.

Although an embodiment of this invention has been disclosed, a worker of ordinary skill in this art would recognize that certain modifications would come within the scope of this disclosure. For that reason, the following claims should be studied to determine the true scope and content of this disclosure.

1. A gas turbine engine comprising:
a first shaft including a first compressor rotor;
a second shaft including a second compressor rotor disposed upstream of the first compressor rotor; and
said second compressor rotor having a first overall pressure ratio, and said first compressor rotor having a second overall pressure ratio, with a ratio of said first overall pressure ratio to said second overall pressure ratio being greater than or equal to about 3.0.

2. The gas turbine engine as set forth in claim 1, wherein said ratio of said first overall pressure ratio to said second overall pressure ratio is greater than or equal to about 3.5.

3. The gas turbine engine as set forth in claim 2, wherein said ratio of said first overall pressure ratio to said second overall pressure ratio being less than or equal to about 8.0.

4. The gas turbine engine as set forth in claim 1, wherein a first turbine rotor drives the first shaft to drive said first compressor rotor, and a second turbine rotor drives the second shaft to drive the second compressor rotor.

5. The gas turbine engine as set forth in claim 4, wherein said first turbine rotor includes a single turbine stage.

6. The gas turbine engine as set forth in claim 5, wherein said second turbine rotor includes two stages.

7. The gas turbine engine as set forth in claim 6, wherein said second compressor rotor includes eight stages.

8. The gas turbine engine as set forth in claim 7, wherein said first compressor rotor includes six stages.

9. The gas turbine engine as set forth in claim 4, wherein a propulsor turbine is positioned downstream of the second turbine rotor.

10. The gas turbine engine as set forth in claim 9, wherein the propulsor turbine drives a propeller.

11. The gas turbine engine as set forth in claim 9, wherein the propulsor turbine drives a fan at an upstream end of the engine.

12. The gas turbine engine as set forth in claim 11, wherein an axially outer position is defined by said fan, and said propulsor turbine being positioned between said fan and said first and second turbine rotors, and said first and second compressor rotors being positioned further into said engine relative to said first and second turbine rotors.

13. The gas turbine engine as set forth in claim 9, wherein said first turbine rotor includes a single turbine stage.

14. The gas turbine engine as set forth in claim 13, wherein said second turbine rotor includes two stages.

15. The gas turbine engine as set forth in claim 14, wherein said second compressor rotor includes eight stages.

16. The gas turbine engine as set forth in claim 15, wherein said first compressor rotor includes six stages.

17. The gas turbine engine as set forth in claim 1, wherein said second compressor rotor includes eight stages.

18. The gas turbine engine as set forth in claim 1, wherein said first compressor rotor includes six stages.

19. The gas turbine engine as set forth in claim 1, wherein said ratio of said first overall pressure ratio to said second overall pressure ratio being less than or equal to about 8.0.

20. A gas turbine engine comprising:
a first shaft connecting a first compressor rotor to be driven by a first turbine rotor;
a second shaft connecting a second compressor rotor to be driven by a second turbine rotor, with said second compressor rotor being upstream of the first compressor rotor, and said first turbine rotor being upstream of said second turbine rotor;
said second compressor rotor having a first overall pressure ratio, and said first compressor rotor having a second overall pressure ratio, with a ratio of said first overall pressure ratio to said second overall pressure ratio being greater than or equal to about 2.0;
a propulsor turbine operatively connected to drive one of a fan or a propeller through a third shaft; and
said first shaft surrounding said second shaft, but said first and second shaft not surrounding said third shaft.

21. The gas turbine engine as set forth in claim 20, wherein said ratio of said first overall pressure ratio to said second overall pressure ratio is greater than about 3.0.

22. The gas turbine engine as set forth in claim 21, wherein said ratio of said first overall pressure ratio to said second overall pressure ratio being less than or equal to about 8.0.

23. The gas turbine engine as set forth in claim 22, wherein said first turbine rotor includes a single turbine stage.

24. The gas turbine engine as set forth in claim 23, wherein said second turbine rotor includes two stages.

25. The gas turbine engine as set forth in claim 24, wherein said second compressor rotor includes eight stages.

26. The gas turbine engine as set forth in claim 25, wherein said first compressor rotor includes six stages.

27. The gas turbine engine as set forth in claim 21, wherein said ratio of said first overall pressure ratio to said second overall pressure ratio is greater than or equal to about 3.5.

28. The gas turbine engine as set forth in claim 20, wherein said propulsor turbine driving a propeller.

29. The gas turbine engine as set forth in claim 20, wherein said propulsor turbine driving a fan at an upstream end of the engine.

30. The gas turbine engine as set forth in claim 29, wherein said propulsor turbine is connected to said fan by a gear reduction.

31. The gas turbine engine as set forth in claim 30, wherein an axially outer position is defined by said fan, and said propulsor turbine being positioned between said fan and said first and second turbine rotors, and said first and second compressor rotors being positioned further into said engine relative to said first and second turbine rotors.

32. The gas turbine engine as set forth in claim 20, wherein said first turbine rotor includes a single turbine stage.

33. The gas turbine engine as set forth in claim 32, wherein said second turbine rotor includes two stages.

34. The gas turbine engine as set forth in claim 33, wherein said second compressor rotor includes eight stages.

35. The gas turbine engine as set forth in claim 34, wherein said first compressor rotor includes six stages.

36. The gas turbine engine as set forth in claim 20, wherein said second compressor rotor includes eight stages.

37. The gas turbine engine as set forth in claim 20, wherein said first compressor rotor includes six stages.

38. The gas turbine engine as set forth in claim 20, wherein said first compressor rotor includes six stages.

39. The gas turbine engine as set forth in claim 20, wherein said ratio of said first overall pressure ratio to said second overall pressure ratio being less than or equal to about 8.0.
